(19) United States
(12) Patent Application Publication
(10) Pub. No.: US 2013/0010003 A1
(43) Pub. Date: Jan. 10, 2013

(54) DISPLAY CONTROL DEVICE, DISPLAY CONTROL METHOD, AND PROGRAM

(75) Inventors: Ikuo Yamano, Tokyo (JP); Yasushi Okumura, Tokyo (JP); Takuro Noda, Tokyo (JP); Qihong Wang, Tokyo (JP)

(73) Assignee: SONY CORPORATION, Tokyo (JP)

(21) Appl. No.: 13/534,500

(22) Filed: Jun. 27, 2012

(30) Foreign Application Priority Data
Jul. 6, 2011 (JP) 2011-150433

(51) Int. Cl. G09G 5/10; G09G 5/00

(52) U.S. Cl. 345/690; 345/204

(57) ABSTRACT

A display control device includes: a display control unit that controls displaying on a display allowing light, which is incident from a rear surface side opposite to an observation surface that is a surface of a side at which an observing user is present, to be transmitted through and to be observed by the user; and a state information acquiring unit that acquires state information representing a rear surface side state of the display, wherein the display control unit changes the displaying on the display in response to the state information.

### CROSS-REFERENCE TO RELATED APPLICATION

The present application claims priority from Japanese Patent Application No. JP 2011-150433 filed in the Japanese Patent Office on Jul. 6, 2011, the entire content of which is incorporated herein by reference.

### FIELD

The present disclosure relates to a display control device, a display control method, and a program.

### BACKGROUND

A transparent display using an OLED (Organic Light-Emitting Diode) or a transmissive LCD (Liquid Crystal Display) is known as a display through which light, which is incident from a rear surface side opposite to an observation surface that is a surface of a side at which an observing user is present, is transmitted and is observed, and is capable of displaying a screen while transmitting, for example, a landscape (hereinafter, also referred to as a background) on the rear surface side. As a technology using the transparent display, for example, a technology, which allows a transparent display provided to a cellular phone terminal to function as an optical finder, is disclosed in JP-A-2010-183378.

### SUMMARY

However, in the transparent display disclosed in JP-A-2010-183378, the background is transmitted through the transparent display and therefore the screen may be hard to view depending on the display content. That is, since the background is transmitted through the transparent display at the time of display, the transparent display may provide convenience that is not provided in normal displays. On the other hand, since the background is transmitted through the transparent display, display characteristics such as visibility or expressiveness may be inferior to the normal displays.

Therefore, it is desirable to provide a display control device, a display control method, and a program, which are new or improved and are capable of also improving display characteristics while obtaining convenience that is realized using a transparent display through which a background is transmitted.

An embodiment of the present disclosure is directed to a display control device including: a display control unit that controls displaying on a display allowing light, which is incident from a rear surface side opposite to an observation surface that is a surface of a side at which an observing user is present, to be transmitted through and to be observed by the user; and a state information acquiring unit that acquires state information representing a rear surface side state of the display. The display control unit changes the displaying on the display in response to the state information.

Another embodiment of the present disclosure is directed to a display control method including: controlling displaying on a display allowing light, which is incident from a rear surface side opposite to an observation surface that is a surface of a side at which an observing user is present, to be transmitted through and to be observed by the user; acquiring state information representing a rear surface side state of the display; and changing the displaying on the display in response to the state information.

Still another embodiment of the present disclosure is directed to a program that allows a computer to execute: a function of controlling displaying on a display allowing light, which is incident from a rear surface side opposite to an observation surface that is a surface of a side at which an observing user is present, to be transmitted through and to be observed by the user; a function of acquiring state information representing a rear surface side state of the display; and a function of changing the displaying on the display in response to the state information.

According to the embodiments of the present disclosure, the state information acquired by the state information acquiring unit shows that the rear surface side state of the display belongs to which state. The display control unit causes a change to the displaying on the display on the basis of the state information. The change in the displaying described here is a concept including various changes of displaying such as a change of display-related parameters of brightness or direction, and a change in the display content. Due to the change, the displaying on the display is adapted to the rear surface side state of the display at that time, and therefore display characteristics such as visibility and expressiveness may be also improved while convenience, which is realized using a transparent display through which a background is transmitted, may be obtained.

As described above, according to the embodiments of the present disclosure, display characteristics may be also improved while obtaining convenience, which is realized using a transparent display through which a background is transmitted.

### BRIEF DESCRIPTION OF THE DRAWINGS

FIGS. 1A and 1B are diagrams illustrating an external appearance of an electronic apparatus according to a first embodiment of the present disclosure;

FIGS. 2A and 2B are diagrams illustrating a screen display example of the electronic apparatus according to the first embodiment of the present disclosure;

FIG. 3 is a block diagram illustrating a schematic functional configuration of the electronic apparatus according to the first embodiment of the present disclosure;

FIGS. 4A and 4B are diagrams illustrating an external appearance of an electronic apparatus according to a second embodiment of the present disclosure;

FIG. 5 is a block diagram illustrating a schematic functional configuration of the electronic apparatus according to the second embodiment of the present disclosure;

FIGS. 6A and 6B are diagrams illustrating an external appearance of an electronic apparatus according to a third embodiment of the present disclosure;

FIGS. 7A and 7B are diagrams illustrating an external appearance of an electronic apparatus according to a fourth embodiment of the present disclosure;

FIGS. 8A and 8B are diagrams illustrating an external appearance of an electronic apparatus according to a fifth embodiment of the present disclosure;

FIGS. 9A to 9D are diagrams illustrating an external appearance of an electronic apparatus according to a sixth embodiment of the present disclosure; and

FIG. 10 is a block diagram illustrating a hardware configuration of an electronic apparatus according to the embodiments of the present disclosure.

### DETAILED DESCRIPTION

Hereinafter, preferred embodiments of the present disclosure will be described in detail with reference to the attached drawings. In addition, in this specification and the drawings, like reference numerals will be given to like parts having substantially the same functions, and redundant description thereof will be omitted.

In addition, description will be made in the following order.

1. First Embodiment (Electronic Apparatus Provided with Openable Transparent Display)

2. Second Embodiment (Electronic Apparatus Provided with Slidable Transparent Display)

3. Third Embodiment (Electronic Apparatus Provided with Detachable Transparent Display)

4. Fourth Embodiment (Electronic Apparatus Provided with Keyboard on Background Surface)

5. Fifth Embodiment (Electronic Apparatus Provided with Solar Cell Panel on Background Surface)

6. Sixth Embodiment (Electronic Apparatus Provided with Transparent Display that is Openable with Respect to Both Surfaces)

7. Hardware Configuration of Electronic Apparatus

8. Brief of Embodiments

9. Supplement

### 1. First Embodiment

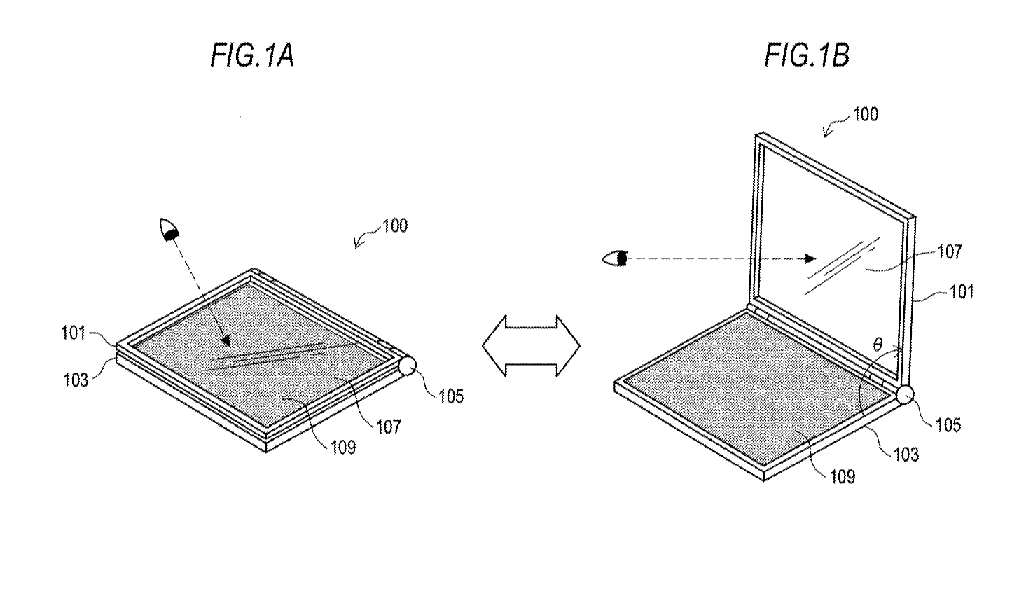

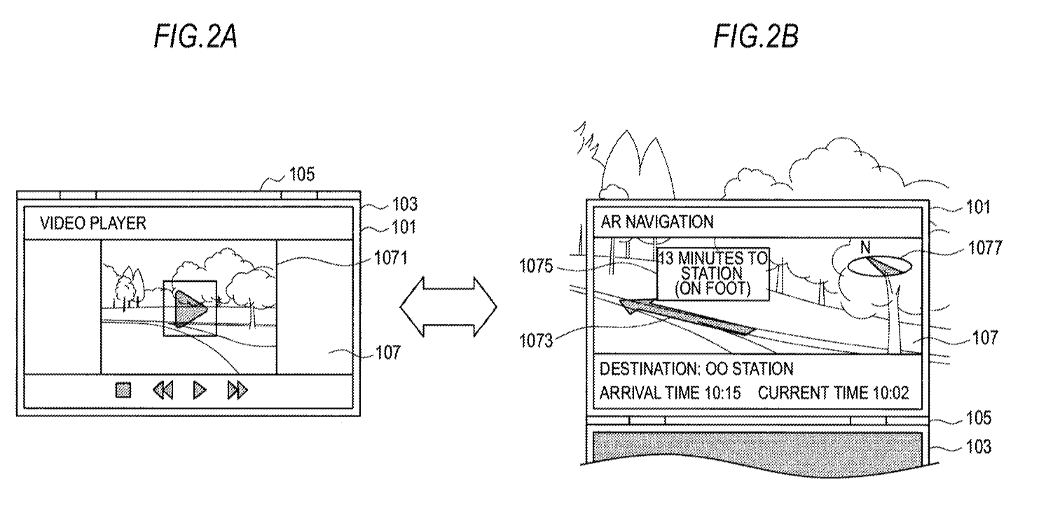

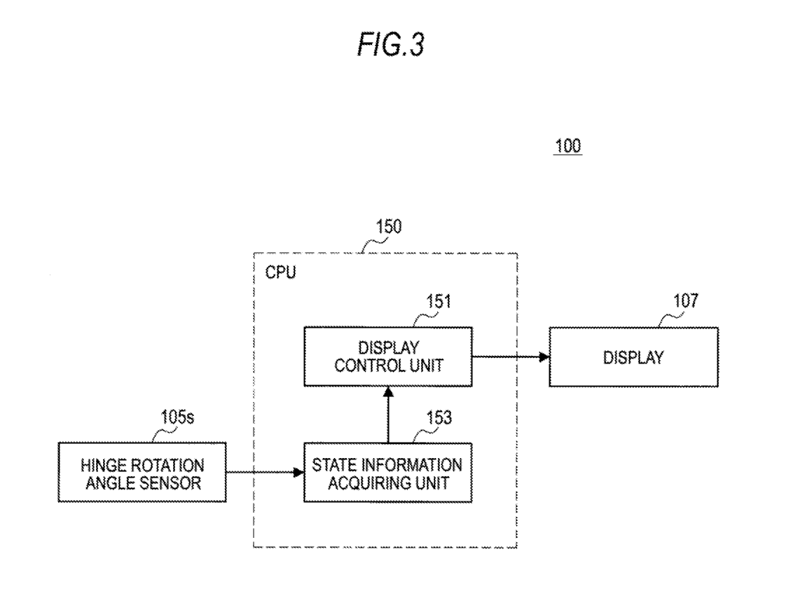

First, a first embodiment of the present disclosure will be described with reference to FIGS. 1A to 3. The first embodiment of the present disclosure is an embodiment related to an electronic apparatus 100 provided with a transparent display that is openable with a hinge with respect to a main body. FIGS. 1A and 1B show diagrams illustrating an external appearance of the electronic apparatus 100. FIGS. 2A and 2B show a diagram illustrating a screen display example of the electronic apparatus 100. FIG. 3 is a block diagram illustrating a schematic functional configuration of the electronic apparatus 100.

### (External Appearance of Apparatus)

Referring to FIGS. 1A and 1B, the electronic apparatus 100 includes a display section 101 and a main body section 103 as a part of casing. The display section 101 and the main body section 103 engage with each other with a hinge 105, and the display section 101 is openable with respect to the main body section 103. FIG. 1A represents a state in which the display section 101 is closed with respect to the main body section 103, and FIG. 1B represents a state in which the display section 101 is opened with respect to the main body section 103. In each of the states, a direction in which a user observes a display 107 provided to the display section 101 is indicated by a schematic user sightline.

As electronic apparatus 100, a tablet type or note-type PC (Personal Computer), a smart phone, a cellular phone, a portable gaming machine, a PDA (Personal Digital Assistant), or the like may be exemplified. The electronic apparatus 100 may be an electronic apparatus that may be grasped by a user in a state in which the display section 101 is opened with respect to the main body section 103, as in FIG. 1B. In this case, the user may make any background such as a surrounding landscape be transmitted through the display 107 for displaying thereon.

The display section 101 includes the display 107. The display 107 is, for example, an OLED, a transmissive LCD, or the like, and is a transparent display allowing light, which is incident from a rear surface side opposite to an observation surface that is a surface of a side at which an observing user is present, to be transmitted through and to be observed by the user. In addition, in the following description, an image that is observed by the transmission of the light on the rear surface side is also called a background of the display 107. A touch panel (not shown) may be provided on one surface or both surfaces of the display 107 to allow a touch operation from a user to be acquired. An interconnection, which connects a display control unit described later and the display 107 so as to display a screen on the display 107, or the like is accommodated in the display unit 101.

The main body section 103 includes a background surface 109. The background surface 109 is, for example, a surface, which overlaps the display 107 in a case where the display unit 101 is closed with respect to the main body section 103 as in FIG. 1A and serves as a background of the display 107, in a surface of the main body section 103. In the background surfaces 109, a color of a portion that overlaps at least the display 107 with each other is, for example, a non-transmissive color such as black. Various circuits such as a CPU (Central Processing Unit) described later, for realizing the functions of the electronic apparatus 100, and the like are accommodated in the main body section 103.

A hinge 105 is a mechanism that makes the display section 101 engage with the main body section 103 in an openable manner. As the hinge 105, various kinds of hinges that are generally used in electronic apparatuses may be used. The hinge 105 is provided with a hinge rotation angle sensor described later. The hinge rotation angle sensor detects the rotation angle of the hinge 105 and provides the angle to a state information acquiring unit as state information representing a rear surface side state of the display 107.

### Display Example

Screen display examples of the display 107 in the cases of FIGS. 1A and 1B are shown in FIGS. 2A and 2B, respectively. In FIG. 2A, an application of a video player is displayed on the display 107. In FIG. 2B, an AR (Augmented Reality) navigation application is displayed on the display 107.

As described above, in the case of FIG. 2A, the display section 101 is closed with respect to the main body section 103, and the display 107 may overlap the background surface 109. That is, the background of the display 107 is the background surface 109 of non-transmissive color. Therefore, in this case, the display 107 may perform displaying in which the background is not transmitted, that is, displaying such as normal displaying. In this manner, a user may reliably view a screen displayed on the display 107 without affected by the change in the background. In addition, in a case where the display 107 is a transparent display using a self-luminescent device such as an OLED, when the background surface 109 is set as a black surface, the color black that is difficult to express in a transparent display using a self-luminescent device may be expressed, such that the expressiveness of the display 107 may be improved. This display is effective, for example, when an image such as a moving picture 1071 is display, or the like.

On the other hand, in the case of FIG. 2B, the display section 101 is opened with respect to the main body section 103, and the display 107 does not overlap the background surface 109. That is, the background of the display 107 is a background landscape of the display 107. Therefore, in this case, the display 107 may perform displaying that is peculiar to the transparent display through which the background is transmitted. For example, like an example shown in the drawing, the display 107 displays information such as an arrow 1073, a necessary time display 1075, and an azimuth display 1077 by using the AR technology in such a manner that the information overlaps the actual landscape. In this case, since the information may be displayed in such a manner that the information overlaps the actual landscape that is transmitted through the display 107 without acquiring a landscape image using a camera or the like, processing load due to an image processing may be reduced.

Here, when a surface of the display 107 that is observed by a user in the state of FIG. 2A is set to a front surface, a surface of the display 107 that is observed by a user in the state of FIG. 2B becomes a rear surface. Therefore, on the display 107, a screen to be observed from the front surface is displayed in the state of FIG. 2A, and an image to be observed from the rear surface is displayed in the state of FIG. 2B. In this case, as can be understood when referring to FIGS. 1A and 1B, in the state of FIG. 2A, the hinge 105 side becomes an upper side, but in the state of FIG. 2B, the hinge 105 side becomes a lower side. That is, a screen that is displayed on the display 107 is vertically inverted between the states of FIGS. 2A and 2B.

### (Functional Configuration)

Referring to FIG. 3, as a functional configuration to control the displaying on the display 107, the electronic apparatus 100 includes a display control unit 151, a state information acquiring unit 153, and a hinge rotation angle sensor 105s. The display control unit 151 and the state information acquiring unit 153 are realized by, for example, a CPU 150 executing a program stored in a non-volatile memory or the like. In addition, with respect to another functional configuration of the electronic apparatus 100, the same configuration as a general electronic apparatus may be used, such that the detailed description thereof will not be repeated.

The display control unit 151 controls the displaying on the display 107. The display control unit 151 provides image data that is displayed as a screen for the display 107, and allows the display 107 to display the screen. The display control unit 151 changes the displaying on the display 107 in response to the state information that represents the rear surface side state of the display 107 and is acquired by the state information acquiring unit 153. Specifically, as described later, the display control unit 151 vertically inverts the displaying on the display 107, changes the display brightness, or changes the display content. In the case of changing the display brightness, the display control unit 151 may cause a change in the brightness with a different value for each portion of the display 107.

The state information acquiring unit 153 acquires the state information representing the rear surface side state of the display 107 and provides this information for the display control unit 151. In this embodiment, the state information is provided by the hinge rotation angle sensor 105s. As described above, the hinge rotation angle sensor 105s detects the rotation angle of the hinge 105 that makes the display section 101 provided with the display 107 and the main body section 103 provided with the background surface 109 that serves as the background of the display 107 engage with each other in an openable manner. The state information acquiring unit 153 may convert this information of the rotation angle to information about whether or not the background of the display 107 is the background surface 109, and may provide this converted information for the display control unit 151.

Here, for example, the hinge rotation angle sensor 105s detects the rotation angle of the hinge 105 with the state, in which the display section 101 is closed with respect to the main body section 103 as shown in FIG. 1A, made as a reference. In this case, as shown in FIG. 1B, the further the display section 101 is opened with respect to the main body section 103, the more the rotation angle θ of the hinge 105 increases. When the rotation angle θ is equal to or less than a predetermined threshold value, the state information acquiring unit 153 determines that the display 107 may overlap the background surface 109 and therefore the background of the display 107 is the background surface 109. On the other hand, when the rotation angle θ is larger than the predetermined threshold value, the state information acquiring unit 153 determines that the display 107 does not overlap the background surface 109 and the background landscape is transmitted through the display 107.

As another example, the state information acquiring unit 153 may use first and second two threshold values. In this case, the second threshold value may be larger than the first threshold value. When the rotation angle θ is equal to or less than the first threshold value, the state information acquiring unit 153 determines that the display 107 overlaps the background surface 109. In addition, when rotation angle θ is equal to or larger than the second threshold value, the state information acquiring unit 153 determines that the display 107 does not overlap the background surface 109 and the background is transmitted through the display 107. When the rotation angle θ is in an intermediate value between the first threshold value and the second threshold value, the state information acquiring unit 153 determines that the display section 101 is in the course of being opened or closed with respect to the main body section 103, in other words, in an intermediate state, and the display control unit 151 makes the displaying on the display 107 temporarily disappear. Therefore, unnecessarily displaying on the display 107 is prevented from being performed while the user does not observe the display 107 in the course of opening/closing the display section 101, such that for example, power consumption may be reduced.

As still another example, the display control unit 151 and the state information acquiring unit 153 may use a hysteresis control with respect to a control based on the determination of the threshold value of the rotation angle θ. For example, in the case of discriminating a case in which the display 107 overlaps the background surface 109 and a case in which the display 107 does not overlap the background surface 109 according to a predetermined threshold value of the rotation angle θ, when the rotation angle θ gradually increases (the display section 101 is made to open), a threshold value θ1 is used, and when the rotation angle θ gradually decreases (the display section 101 is made to close), a threshold value θ2 is used. In this case, the threshold value θ1 may be larger than the threshold value θ2. In this manner, for example, in a case where the rotation angle θ varies minutely before and after the threshold value, the displaying on the display 107 may be prevented from being frequently changed and giving the user the impression of being cumbersome.

### Display Control Example

In regard to the first embodiment of the present disclosure that has been described with reference to FIGS. 1A to 3, a display control example of the display 107 by the display control unit 151 will be further described. In this embodiment, the display control unit 151 changes the displaying on the display 107 in response to the state information that is acquired by the state information acquiring unit 153. Specifically, the state information is the rotation angle of the hinge 105, and may be called information that represents whether or not the display 107 overlaps the background surface 109.

First, the display control unit 151 may vertically invert the displaying on the display 107 in response to the rear surface side state of the display 107. Specifically, the display control unit 151 vertically inverts the displaying on the display 107 between a case where it is determined that the background of the display 107 is the background surface 109 and not the case from the rotation angle of the hinge 105 which is acquired by the state information acquiring unit 153. As described with reference to FIGS. 2A and 2B, in this embodiment, surfaces that are observed by the user of the display 107 are different from each other between a case in which the background of the display 107 is the background surface 109 and a case in which the background of the display 107 is not the background surface 109. Therefore, the display control unit 151 vertically inverts the displaying on the display 107 between the two cases, and makes screens be correctly viewed, in the respective cases.

In addition, in an example shown in FIGS. 2A and 2B, since the hinge 105 side corresponds to an upper side or a lower side of the screen displayed on the display 107, the display control unit 151 vertically converts the displaying on the display 107. On the other hand, for example, in a case where the hinge 105 side corresponds to the right side or the left side of the screen displayed on the display 107 (in a case where the display 107 is vertically disposed instead of being horizontally disposed like an example shown in FIGS. 2A and 2B), the display control unit 151 may horizontally invert the displaying on the display 107.

Secondly, the display control unit 151 may change the brightness in the displaying on the display 107 in response to the rear surface side state of the display 107. Specifically, the display control unit 151 changes the brightness in the displaying on the display 107 between a case where it is determined that the background of the display 107 is the background surface 109 and not the case from the rotation angle of the hinge 105 which is acquired by the state information acquiring unit 153. As described above, display characteristics of the display 107 such as visibility and color expressiveness are different between a case in which the display 107 sets the non-transmissive background surface 109 as the background and not the case. Therefore, the optimal brightness of each pixel of the display 107 is different in each case. The display control unit 151 changes the brightness in displaying on the display 107 in accordance with these characteristics, and realizes the optimal display in accordance with the background in each case.

Thirdly, the display control unit 151 may change display content of the display 107 in response to the rear surface side state of the display 107. For example, in a case where the rotation angle of the hinge 105 varies in a state in which the screen including the transmissive display of the AR information is displayed on the display 107 as shown in FIG. 2B, and therefore the background of the display 107 is switched to the background surface 109, the display control unit 151 may terminate the display of the screen including the transmissive display of the AR information. In addition, in a case where the background of the display 107 is switched to the background surface 109, the display control unit 151 may change the display content from a screen in which the AR information overlaps an actual landscape that is transmitted through the display 107, to a screen in which the AR information overlaps a landscape image acquired by using a camera or the like that is installed in the electronic apparatus 100.

### 2. Second Embodiment

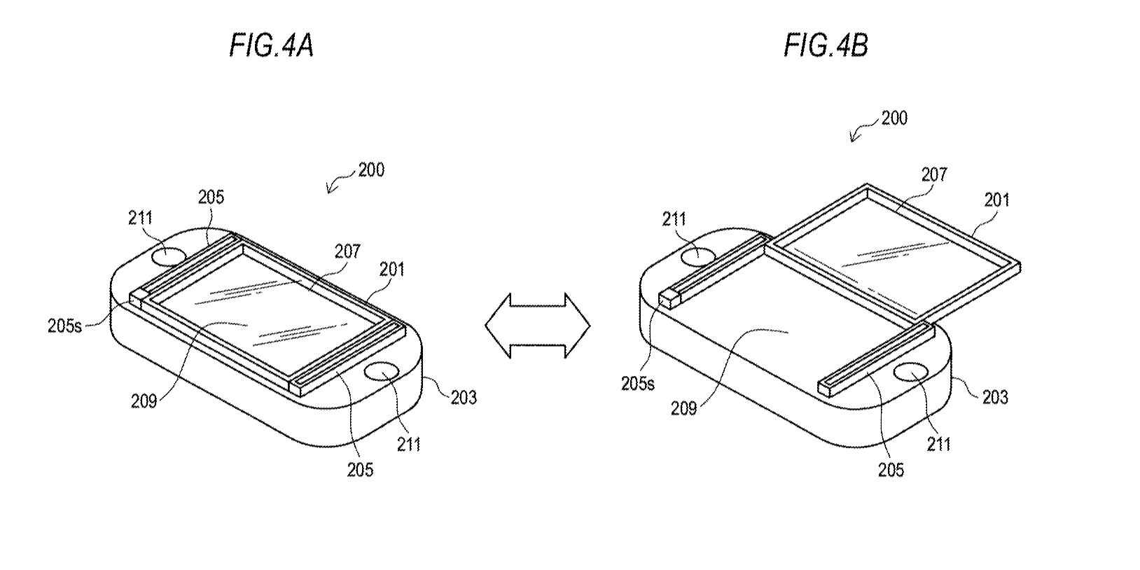

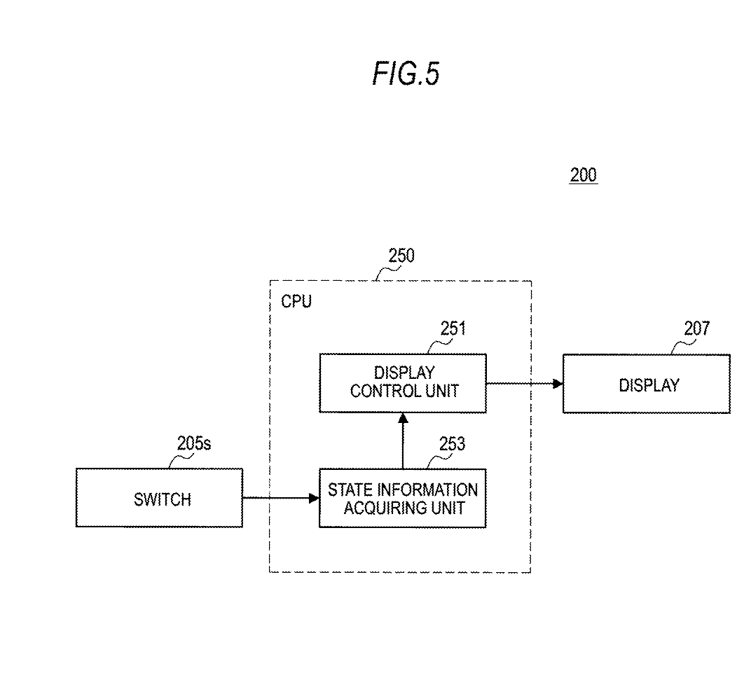

Next, a second embodiment of the present disclosure will be described with reference to FIGS. 4A to 5. The second embodiment of the present disclosure is an embodiment related to an electronic apparatus 200 that includes a transparent display that is slidable with respect to the main body with a slide mechanism. FIGS. 4A and 4B are diagrams illustrating an external appearance of the electronic apparatus 200. FIG. 5 shows a block diagram illustrating a schematic functional configuration of the electronic apparatus 200.

### (External Appearance)

Referring to FIGS. 4A and 4B, the electronic apparatus 200 includes a display section 201 and a main body section 203 as a part of casing. The display section 201 and the main body section 203 engage with each other with a slide mechanism 205, and the display section 201 is slidable with respect to the main body section 203. FIG. 4A shows a state in which the display section 201 overlaps the top face of the main body section 203, and FIG. 4B shows a state in which the display section 201 slides along the top face of the main body section 203 and projects from the top face of the main body section 203.

As the electronic apparatus 200, a tablet type or note-type PC, a smart phone, a cellular phone, a portable gaming machine, a PDA (Personal Digital Assistant), or the like may be exemplified. The electronic apparatus 200 may be an electronic apparatus that may be grasped by a user in a state in which the display section 201 projects from the top face of the main body section 203 as in FIG. 4B. In this case, the user may make any background such as a surrounding landscape be transmitted through the display 207, which is provided in the display section 201, for displaying thereon.

The display section 201 includes the display 207. The display 207 is a transparent display using, for example, an OLED, a transmissive LCD, or the like. A touch panel (not shown) may be provided on the top face of the display 207 to allow a touch operation from a user to be acquired. An interconnection, which connects a display control unit described later and the display 207 so as to display a screen on the display 207, or the like is accommodated in the display unit 201.

The main body section 203 includes a background surface 209. For example, the background surface 209 is a surface, which overlaps the display 207 in a case where the display unit 201 overlaps the top face of the main body section 203 as in FIG. 4A and serves as a background of the display 207, in a surface of the main body section 203. In the background surfaces 209, the color of a portion that overlaps at least the display 207 with each other is, for example, a non-transmissive color such as black. Various circuits such as a CPU (Central Processing Unit) described later, for realizing the functions of the electronic apparatus 200, and the like are accommodated in the main body section 203. In addition, an operation unit such as an operation button 211 may be provided in the main body section 203.

The slide mechanism 205 is a mechanism that allows the display section 201 to engage with the main body section 203 in a sliding manner. As the slide mechanism 205, for example, various slide mechanisms such as a mechanism in which a projection bar and an indentation bar are combined may be used. A switch 205s that detects the position of the display section 201 is provided in the slide mechanism 205. For example, as shown in the drawings, the switch 205s may be a switch that is provided in the vicinity of the end portion of the slide mechanism 205, and is switched when the display section 201 slides to the position of the switch 205s. The switch 205s supplies a detection result to a state information acquiring unit described later as state information representing the state of the display 207.

### Display Example

For example, screens displayed on the display 207 in the case of FIGS. 4A and 4B are the same as the screens described with reference to FIGS. 2A and 2B.

That is, in the case of FIG. 4A, the display section 201 overlaps the top face of the main body section 203, and the display 207 overlaps the background surface 209. That is, the background of the display 207 is the background surface 209 of non-transmissive color. Therefore, in this case, the display 207 may perform displaying in which the background is not transmitted, that is, displaying such as normal displaying.

On the other hand, in the case of FIG. 4B, the display section 201 projects from the top face of the main body section 203, and the display 207 does not overlap the background surface 209. That is, the background of the display 207 is a background landscape of the display 207. Therefore, in this case, the display 207 may perform displaying that is peculiar to the transparent display through which the background is transmitted.

In addition, in this second embodiment, since the display section 201 moves by the slide mechanism 205, a surface of the display 207 that is observed by a user does not vary between the states of FIGS. 4A and 4B. Therefore, in this embodiment, differently from the first embodiment, it is not necessary to vertically invert the screen displayed on the display 207 between the states of FIGS. 4A and 4B.

### (Functional Configuration)

Referring to FIG. 5, the electronic apparatus 200 includes a display control unit 251, a state information acquiring unit 253, and the switch 205s, as a functional configuration to control displaying on the display 207. The display control unit 251 and the state information acquiring unit 253 are realized by, for example, a CPU 250 executing a program stored in a non-volatile memory or the like. In addition, with respect to another functional configuration of the electronic apparatus 200, the same configuration as a general electronic apparatus may be used, such that a detailed description thereof will not be repeated.

The display control unit 251 controls the displaying on the display 207. The display control unit 251 provides image data that is displayed as a screen for the display 207, and allows the display 207 to display the screen. The display control unit 251 changes the displaying on the display 207 in response to the state information that represents the rear surface side state of the display 207 and is acquired by the state information acquiring unit 253. Specifically, as described later, the display control unit 251 changes the display brightness of the display 207 or the display content. In the case of changing the display brightness, the display control unit 251 may cause a change in the brightness with a different value for each portion of the display 207.

The state information acquiring unit 253 acquires the state information representing the rear surface side state of the display 207 and provides this information for the display control unit 251. In this embodiment, the state information is provided by the switch 205s. As described above, the switch 205s is provided in the slide mechanism 205, which makes the display section 201 provided with the display 207 and the main body section 203 provided with the background surface 209 that serves as the background of the display 207 engage with each other in a sliding manner, and detects the position of the display section 201. The state information acquiring unit 253 may convert this information of the position to, for example, information about whether or not the background of the display 207 is the background surface 209, and may provide this converted information for the display control unit 251.

Here, the switch 205s may be a switch that is provided in the vicinity of the end portion of the slide mechanism 205, and is switched when the display section 201 slides to the position of the switch 205s. For example, when it is assumed that the switch 205s is turned on in a case where the display section 201 slides to the position of the switch 205s, in a case where the switch 205s is turned on, the state information acquiring unit 253 determines that the display 207 overlaps the background surface 209 and the background of the display 207 is the background surface 209. On the other hand, in a case where the switch 205s is turned off, the state information acquiring unit 253 determines that the display 207 does not overlap the background surface 209 and the background is transmitted through the display 207.

As another example, the switch 205s may be provided at a plurality of positions of the slide mechanism 205. In this case, two switches 205s may be provided, for example, in the vicinity of the lower-left end and the upper-right end of the slide mechanism 205 in FIGS. 4A and 4B. For example, when it is assumed that each of the switches 205s is turned on in a case where the display section 201 slides to each of the positions of the switches 205s, the state information acquiring unit 253 determines that the display 207 overlap the background surface 209 in a case where both of the two switches 205s are turned on. In addition, when both of the two switches 205s are turned off, the state information acquiring unit 253 determines that the display 207 does not overlap the background surface 209 and the background landscape is transmitted through the display 207. In a case where one (that is in the vicinity of the upper-right end) of the switches 205s is turned on, and the other (that is in the vicinity of the lower-left end) is turned off, the state information acquiring unit 253 determines that the display section 201 is in the course of sliding with respect to the main body section 203, and the display control unit 251 makes the displaying on the display 207 temporarily disappear. Therefore, unnecessarily displaying on the display 207 is prevented from being performed while the user does not observe the display 207 in the course of sliding the display section 201, such that for example, power consumption may be reduced.

### Display Control Example

In regard to the second embodiment of the present disclosure that has been described with reference to FIGS. 4A to 5, a display control example of the display 207 by the display control unit 251 will be further described.

As described above, in this embodiment, the position of the display section 201, which is detected by the switch 205s provided to the slide mechanism 205, is acquired as the state information. In addition, in this embodiment, since the surface of the display 207, which is observed by the user, does not vary even when the background of the display 207 varies, it is not necessary for the display control unit 251 to vertically or horizontally invert the displaying on the display 207 in response to the state of the display 207. Other than this control, the display control by the display control unit 251 in regard to the change in display brightness of the display 207 and the change in display content of the display 207 in response to the state information is the same as the display control by the display control unit 151 in the above-described first embodiment.

### 3. Third Embodiment

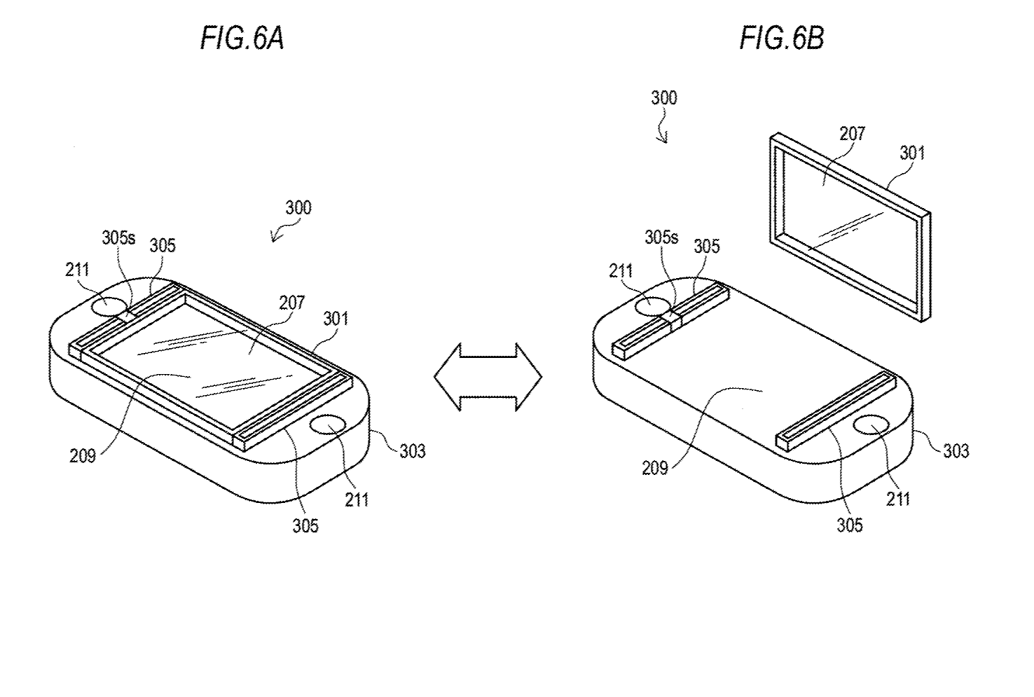

Next, a third embodiment of the present disclosure will be described with reference to FIGS. 6A and 6B. The third embodiment of the present disclosure is an embodiment related to an electronic apparatus 300 that includes a transparent display that is detachable with respect to the main body by an attaching and detaching mechanism. FIGS. 6A and 6B are diagrams illustrating an external appearance of the electronic apparatus 300.

In addition, a configuration of the electronic apparatus 300 according to the third embodiment is different from that of the electronic apparatus 200 according to the second embodiment in that an attaching and detaching mechanism 305 and a switch 305s shown in FIGS. 6A and 6B are used instead of the slide mechanism 205 and the switch 205s. However, configurations of other portions are the same as the electronic apparatus 200, such that the detailed description thereof will not be repeated.

### (External Appearance of Apparatus)

Referring to FIGS. 6A and 6B, the electronic apparatus 300 includes a display section 301 and a main body section 303 as a part of casing. The display section 301 and the main body section 303 engage with each other with the attaching and detaching mechanism 305, and the display section 301 is detachable with respect to the main body section 303. FIG. 6A shows a state in which the display section 301 is attached on the top face of the main body section 303, and FIG. 6B shows a state in which the display section 301 is detached from the main body section 303.

As the electronic apparatus 300, a tablet type or note-type PC, a smart phone, a cellular phone, a portable gaming machine, a PDA (Personal Digital Assistant), or the like may be exemplified. The electronic apparatus 300 may be an electronic apparatus that may be grasped by a user in a state in which the display section 301 is detached from the main body section 303 as in FIG. 4B. In this case, the user may make any background such as a surrounding landscape be transmitted through the display 207, which is provided in the display section 301, for displaying thereon.

The display section 301 includes the display 207. In this embodiment, the display section 301 may be physically separated from the main body section 303. Therefore, a communication circuit, which connects the display control unit 251 provided to the main body section 303 and the display 207 by a radio communication such as Bluetooth (registered trademark) so as to display a screen on the display 207, or the like is accommodated in the display section 301.

The main body section 303 includes the background surface 209. In addition to various circuits such as a CPU that realizes a function of the electronic apparatus 300, a communication circuit that connects the display control unit 251 and the display 207 with a radio communication, or the like is accommodated in the main body section 303. In addition, an operation unit such as the operation button 211 may be provided in the main body section 303.

The attaching and detaching mechanism 305 is a mechanism that makes the display section 301 detachably engage with the main body section 303. As the attaching and detaching mechanism 305, for example, various attaching and detaching mechanisms such as a mechanism in which a claw portion and a concave portion are combined may be used. The switch 305s that detects an attached or detached state of the display section 301 is provided in the attaching and detaching mechanism 305. For example, as shown in the drawings, the switch 305s may be a switch that is provided at a predetermined portion of the attaching and detaching mechanism 305 and is switched when the display section 301 is attached on the main body section 303. The switch 305s supplies a detection result to a state information acquiring unit 253 as state information representing the rear surface side state of the display 207.

### Display Example

For example, screens displayed on the display 207 in the case of FIGS. 6A and 6B are the same as the screens described with reference to FIGS. 2A and 2B.

That is, in the case of FIG. 6A, the display section 301 is attached on the top face of the main body section 303, and the display 207 overlaps the background surface 209. That is, the background of the display 207 is the background surface 209 of non-transmissive color. Therefore, in this case, the display 207 may perform displaying in which the background is not transmitted, that is, displaying such as normal displaying.

On the other hand, in the case of FIG. 6B, the display section 301 is detached from the main body section 303, and the display 207 does not overlap the background surface 209. That is, the background of the display 207 is a background landscape of the display 207. Therefore, in this case, the display 207 may perform displaying that is peculiar to the transparent display through which the background is transmitted.

In addition, in this third embodiment, a surface of the display 207 that is observed by a user in a state in which the display section 301 is detached from the main body section 303 (FIG. 6B), and a surface that is observed in the state of FIG. 6A may be the same as each other or may be different from each other. Therefore, in this embodiment, the screen that is displayed on the display 207 may be vertically or horizontally inverted between the states of FIGS. 6A and 6B as in the first embodiment, or the screen may not inverted as in the second embodiment.

### (Functional Configuration)

A functional configuration of the electronic apparatus 300 is the same as the electronic apparatus 200 according to the above-described second embodiment except that the switch 305s is used instead of the switch 205s.

For example, the switch 305s may be a switch that is provided at a portion at which the attaching and detaching mechanism 305 is provided, and is switched when the display section 301 is attached to the attaching and detaching mechanism 305. For example, when it is assumed that the switch 305s is turned on in a case where the display section 301 is attached to the main body section 303, the state information acquiring unit 253 determines that the display 207 overlaps the background surface 209 and the background of the display 207 is the background surface 209 in a case where the switch 305s is turned on. On the other hand, in a case where the switch 305s is turned off, the state information acquiring unit 253 determines that the display 207 does not overlap the background surface 209 and the background is transmitted through the display 207.

As another example, the switch 305s may be provided at a plurality of positions of the attaching and detaching mechanism 305. In this case, the switch 305s may be provided, for example, at two attaching and detaching mechanisms 305 in FIGS. 6A and 6B, respectively. For example, when it is assumed that the switch 305s is turned on in a case where the display section 301 is attached to the main body section 303, in a case where both of the two switches 305s are turned on, the state information acquiring unit 253 determines that the display 207 overlaps the background surface 209. In addition, in a case where both of the two switch 305s are turned off, the state information acquiring unit 253 determines that the display 207 does not overlap the background surface 209 and the background is transmitted through the display 207. In a case where one of the switches 305s is turned on and the other is turned off, the state information acquiring unit 253 determines that the display section 301 is in the course of being attached to the main body section 303 or the display section 301 is in the course of being detached from the main body section 303, and the display control unit 251 makes the displaying on the display 207 temporarily disappear. Therefore, unnecessarily displaying on the display 207 is prevented from being performed while the user does not observe the display 207 in the course of attaching or detaching the display section 301, such that for example, power consumption may be reduced.

### Display Control Example

In regard to the third embodiment of the present disclosure that has been described with reference to FIGS. 6A and 6B, a display control example of the display 207 by the display control unit 251 will be further described.

As described above, in this embodiment, in a case where the background of the display 207 is changed, the surface of the display 207, which is observed by the user, may be changed or may not be changed. Therefore, the display control unit 251 may vertically or horizontally invert the displaying on the display 207 in response to the state of the display 207, or may not perform this inversion. Other than this control, the display control by the display control unit 251 in regard to the change in display brightness of the display 207 and the change in display content of the display 207 in response to the state information is the same as the display control by the display control unit 151 in the above-described first embodiment.

### 4. Fourth Embodiment

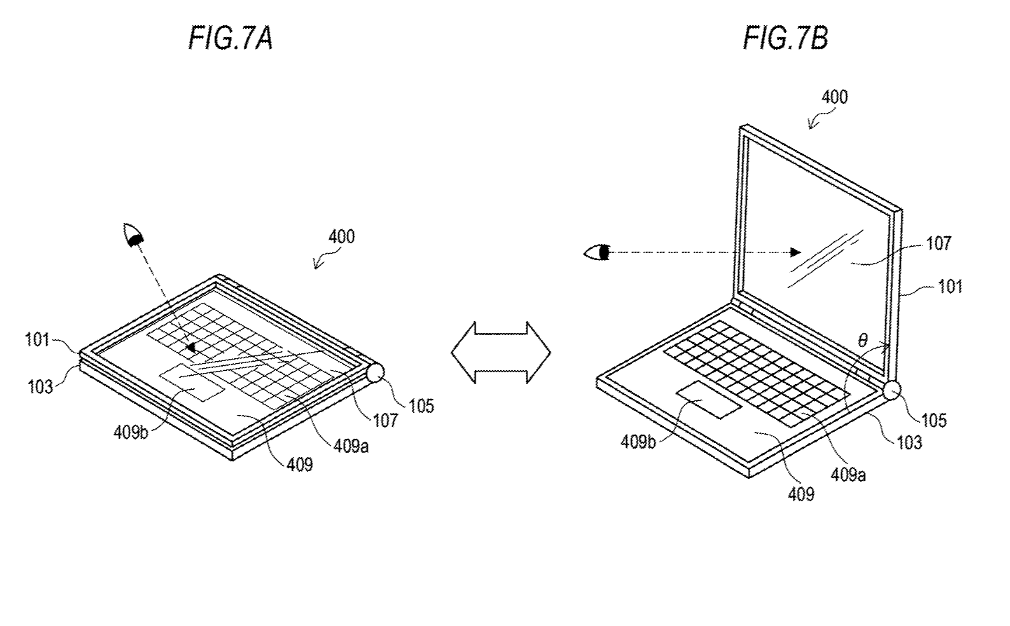

Next, a fourth embodiment of the present disclosure will be described with reference to FIGS. 7A and 7B. This fourth embodiment of the present disclosure is an embodiment related to an electronic apparatus 400 provided with a transparent display that is openable with respect to a main body with a hinge. FIGS. 7A and 7B show diagrams illustrating an external appearance of the electronic apparatus 400.

The electronic apparatus 400 has the same configuration as the electronic apparatus 100 according to the first embodiment except that a keyboard 409a and a touch pad 409b are provided on a background surface 409. A detailed description with respect to the common portions will not be repeated.

Referring to FIGS. 7A and 7B, in the electronic apparatus 400, the keyboard 409a and the touch pad 409b are provided on the background surface 409 of the main body section 103. The keyboard 409a is a so-called hardware keyboard, and various configurations that are generally used by electronic apparatuses may be adopted thereto. The touch pad 409b is an input device that detects contact with a user, and various configurations that are generally used may be also adopted thereto.

Here, in the fourth embodiment, the displaying on the display 107 in the state of FIG. 7B is the same as the first embodiment. On the other hand, the displaying on the display 107 in the state of FIG. 7A is different from the first embodiment in that a display control is performed in correspondence with the keyboard 409a and the touch pad 409b that are provided on the background surface 409 that becomes the background of the display 107. That is, in FIG. 7A, since the keyboard 409a and the touch pad 409b are seen with being transmitted through the display 107, the display control is performed in consideration of these.

In regard to the keyboard 409a, respective keys are formed in a protruded shaped, and for example, characters such as “Q”, “W”, and “E” are indicated on the keys. In addition, the touch pad 409b may be formed in a recessed shape compared to the background surface 409 or may have a color different from that of the peripheral background surface 409 so as to indicate a region in which the touch operation is possible. When this shape or color is transmitted through the display 107 and is viewed to a user, visibility or expressiveness of the display 107 in the state of FIG. 7A may be deteriorated compared to a case in which the background surface is a plain surface as in the first embodiment, or discomfort may be caused to the user.

Therefore, the display control unit 151 sets a variation in brightness to be a value different in each portion of the display 107 so as to cancel the shape or color of the keyboard 409a and touch pad 409b at the time of changing the display brightness in response to the rear surface side state of the display 107. Therefore, the visibility or expressiveness in the displaying on the display 107 is improved, such that the user who observes the display 107 in the state of FIG. 7A may not be so conscious of the keyboard 409a or the touch pad 409b.

In addition, in a case where the keyboard 409a or the touch pad 409b has a non-transmissive color like the peripheral background surface 409, for example, black, even when the control of the display control unit 151 as described above is not performed, the visibility or expressiveness in the displaying on the display 107 in the state of FIG. 7A may be sufficiently improved compared to the state of FIG. 7B. For example, when the characters of the keyboard 409a is set to be displayed with illumination and the illumination display is made to disappear in the state of FIG. 7A, an effect, which is caused to the displaying on the display 107 due to the keyboard 409a, may be further reduced. However, the visibility or expressiveness in the displaying on the display 107 in the state of FIG. 7A may be further improved by performing the control of the display control unit 151 as described above.

### 5. Fifth Embodiment

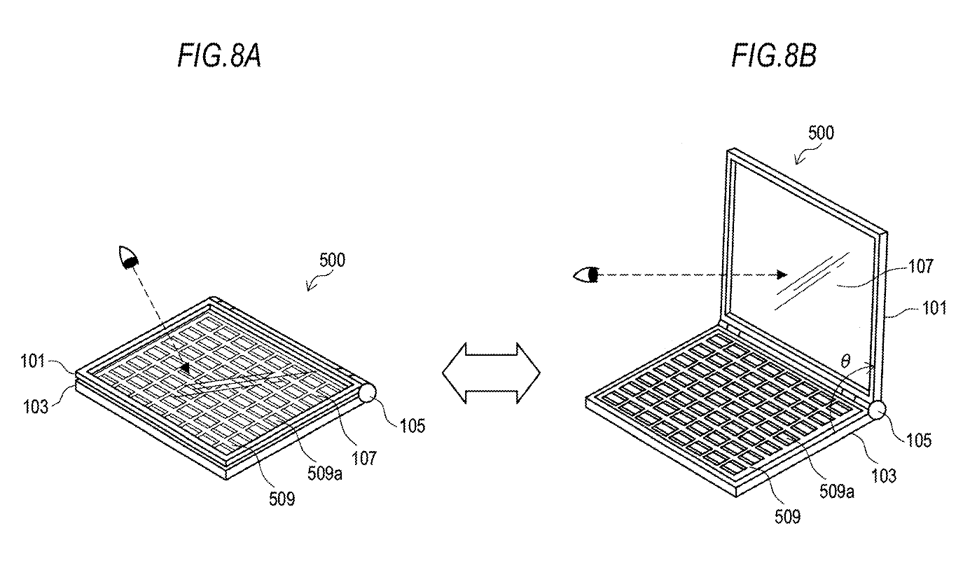

Next, a fifth embodiment of the present disclosure will be described with reference to FIGS. 8A and 8B. This fifth embodiment of the present disclosure is an embodiment related to an electronic apparatus 500 provided with a transparent display that is openable with respect to a main body with a hinge. FIGS. 8A and 8B show diagrams illustrating an external appearance of the electronic apparatus 500.

The electronic apparatus 500 has the same configuration as the electronic apparatus 100 according to the first embodiment except that a solar cell panel 509a is provided on a background surface 509. A detailed description with respect to the common portions will not be repeated.

Referring to FIGS. 8A and 8B, in the electronic apparatus 500, the solar cell panel 509a is provided on the background surface 509. The solar cell panel 509a is a panel of a solar cell, and receives light such as solar light to generate electricity. The solar cell panel 509a may be disposed at the entirety of the background surface 509, or may be disposed at a part thereof. As the solar cell panel 509a, various solar cell panels may be used regardless of the example shown in the drawing.

Here, in this fifth embodiment, displaying on the display 107 in the state of FIG. 8B is the same as the first embodiment. On the other hand, the displaying on the display 107 in the state of FIG. 8A is different from the first embodiment in that a display control is performed in correspondence with the solar cell panel 509a provided on the background surface 509 that becomes the background of the display 107. That is, in FIG. 8A, since the solar cell panel 509a is seen with being transmitted through the display 107, the display control considering this is performed.

In the solar cell panel 509a, for example, a crystal portion and a frame portion are different in a material, and therefore a color or gloss is different in each case. When this color or gloss is transmitted through the display 107 and is viewed to a user, visibility or expressiveness in the displaying on the display 107 in the state of FIG. 8A may be deteriorated compared to a case in which the background surface is a plain surface as in the first embodiment, or discomfort may be caused to the user.

Therefore, the display control unit 151 sets a variation in brightness to be a value different in each portion of the display 107 so as to cancel the color or gloss of the solar cell panel 509a at the time of changing the display brightness in response to the rear surface side state of the display 107. Therefore, the visibility or expressiveness in the displaying on the display 107 is improved, such that the user who observes the display 107 in the state of FIG. 8A may not be so conscious of the solar cell panel 509a.

In addition, in a case where the solar cell panel 509a has a non-transmissive color like the peripheral background surface 509, for example, black, even when the control of the display control unit 151 as described above is not performed, the visibility or expressiveness in the displaying on the display 107 in the state of FIG. 8A may be sufficiently improved compared to the state of FIG. 8B. However, the visibility or expressiveness in the displaying on the display 107 in the state of FIG. 8A may be further improved by performing the control of the display control unit 151 as described above.

### 6. Sixth Embodiment

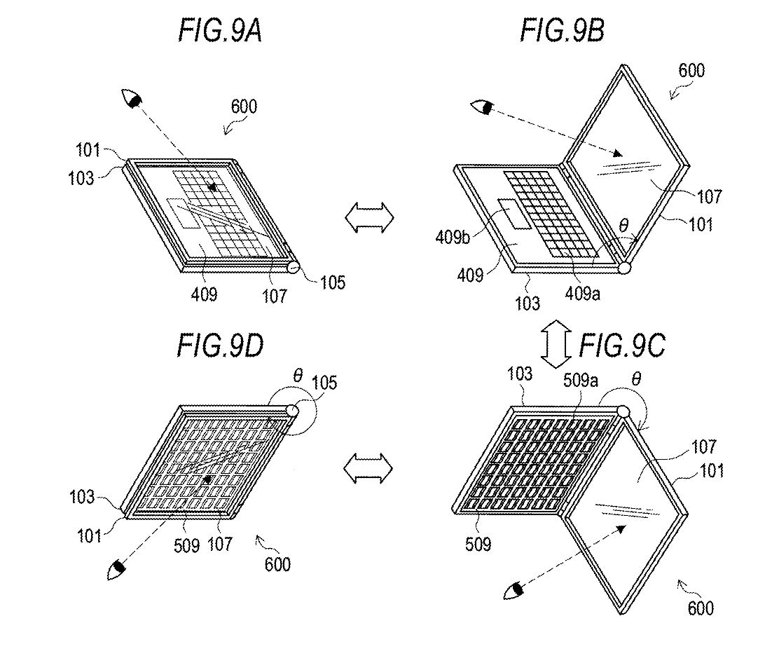

Next, a sixth embodiment of the present disclosure will be described with reference to FIGS. 9A to 9D. This sixth embodiment of the present disclosure is an embodiment related to an electronic apparatus 600 provided with a transparent display that is openable with respect to both surfaces of a main body with a hinge. FIGS. 9A to 9D show diagrams illustrating an external appearance of the electronic apparatus 600.

The electronic apparatus 600 has the same configuration as the electronic apparatus 100 according to the first embodiment except that a background surface 409 and a background surface 509 are provided on both surfaces of the main body section 103, respectively. In addition, the background surface 409 is the same as the background surface 409 of the electronic apparatus 400 according to the above-described fourth embodiment. Furthermore, the background surface 509 is the same surface as the background surface 509 of the electronic apparatus 500 according to the above-described fifth embodiment. A detailed description with respect to the common portions will not be repeated.

Referring to FIGS. 9A to 9D, in the electronic apparatus 600, when the hinge 105 is made to rotate from a state in which the display 107 and the background surface 409 overlap each other as shown in FIG. 9A, it enters a state in which the display section 101 is opened with respect to the main body section 103 on the background surface 409 side as shown in FIG. 9B. From the state shown in FIG. 9B, when the hinge 105 is further made to rotate, it enters a state in which the display section 101 is further opened with respect to the main body section 103 on the background surface 509 side as shown in FIG. 9C. From the state shown in FIG. 9C, when the hinge 105 is further made to rotate, it enters a state in which the display 107 and the background surface 509 overlap each other as shown in FIG. 9D. In each of the states, a direction in which a user observes the display 107 provided to the display section 101 is indicated by a schematic user sightline.

That is, in this embodiment, the rotation angle θ of the hinge 105 may be substantially 0° to 360°. In the example shown in FIGS. 9A to 9D, in a case where the rotation angle θ is close to 0°, it enters the state shown in FIG. 9A in which the display 107 and the background surface 409 overlap each other, and in a case where the rotation angle θ is close to 360°, it enters the state shown in FIG. 9D in which the display 107 and the background surface 509 overlap each other.

Therefore, in this embodiment, the display control unit 151 controls the displaying on the display 107 in response to each of the above-described states. Specifically, in the state shown in FIG. 9A, the display control unit 151 changes the display brightness of the display 107 so as to cancel the shape or color of the keyboard 409a and the touch pad 409b provided on the background surface 409. In the state shown in FIG. 9B, the display control unit 151 changes the display brightness to brightness that is appropriate for a case in which the background landscape is transmitted through the display 107. In addition, the display control unit 151 vertically converts the displaying on the display 107 between the state shown in FIG. 9A and the state shown in FIG. 9B. The display control unit 151 may change the display content of the display 107 between the state shown in FIG. 9A and the state shown in FIG. 9B.

Furthermore, in the state shown in FIG. 9C, in a case where the display 107 is observed from a side different from the state shown in FIG. 9B like an example shown in the drawing, the display control unit 151 horizontally inverts the displaying on the display 107 between the state shown in FIG. 9B and the state shown in FIG. 9C. In the state shown in FIG. 9D, the display control unit changes the display brightness of the display 107 so as to cancel out the color or gloss of the solar cell panel 509a on the background surface 509. In addition, the display control unit 151 vertically inverts the displaying on the display 107 between the state shown in FIG. 9C and the state shown in FIG. 9D. The display control unit 151 may change the display content of the display 107 between the state shown in FIG. 9C and the state shown in FIG. 9D.

On the other hand, the state information acquiring unit 153 discriminates the states shown in FIGS. 9A to 9D using a plurality of threshold values with respect to the rotation angle θ of the hinge 105. For example, in regard to the rotation angle θ, the state information acquiring unit 153 may use a first threshold value to discriminate the states shown in FIGS. 9A and 9B, a second threshold value to discriminate the states shown in FIGS. 9B and 9C, and a third threshold value to discriminate the states shown in FIGS. 9C and 9D. In the example shown in the drawings, the first threshold value may be a value that is close to 0°, the second threshold value may be a value that is close to 180°, and the third threshold value may be a value close to 360°. Also in the sixth embodiment, similarly to the first embodiment, the state information acquiring unit 153 may define an intermediate state of each of the states and the display control unit 151 may make the displaying on the display 107 temporarily disappear in the intermediate state. Furthermore, a hysteresis control may be used with respect to a control based on the determination of the threshold value of the rotation angle θ.

### 7. Hardware Configuration of Electronic Apparatus

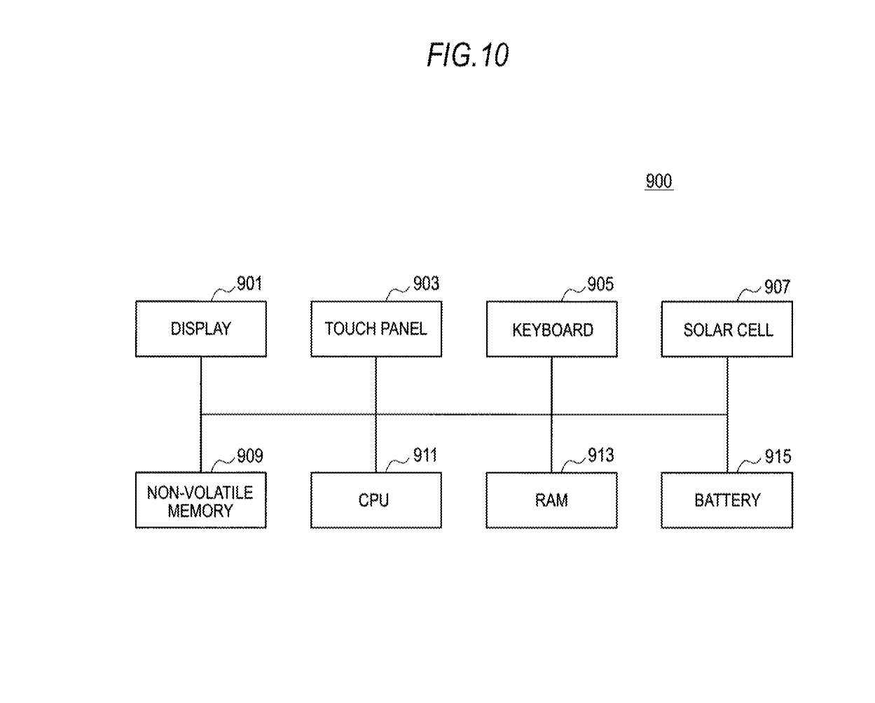

An example of a hardware configuration of an electronic apparatus according to the embodiments of the present disclosure will be described with reference to FIG. 10. FIG. 10 shows a block diagram showing hardware configuration of the electronic apparatus 900. The electronic apparatus 900 is an electronic apparatus that is capable of realizing the electronic apparatuses 100, 200, 300, 400, 500, and 600 according to the respective embodiments of the present disclosure.

The electronic apparatus 900 includes a display 901, a touch panel 903, a keyboard 905, a solar cell 907, a non-volatile memory 909, a CPU 911, a RAM (Random Access Memory) 913, and a battery 915. These constituent elements are connected to each other via, for example, a bus line, a power supply line, or the like.

The display 901 is a display device that corresponds to the displays 107 and 207 in the respective embodiments. The display 901 is a transparent display using an OLED, a transmissive LCD, or the like, and displays an image according to a control of the CPU 911.

The touch panel 903 is an input device that may be provided on a surface of the display 901 in the respective embodiments. The touch panel 903 acquires contact with a user as an operation input with respect to the electronic apparatus 900.

The keyboard 905 is an input device that corresponds to the keyboard 409a in the fourth and sixth embodiments. The keyboard 905 may not be provided in other embodiments. Another input device such as a touch pad and an operation button may be provided in the electronic apparatus 900, together with the keyboard 905 or instead of this.

The solar cell 907 corresponds to the solar cell panel 509a in the fifth and sixth embodiments. The solar cell 907 may not be provided in other embodiments. The solar cell 907 receives solar light to generate electricity and supplies power to the battery 915.

The non-volatile memory 909 is a memory that stores various kinds of information, which are used in the electronic apparatus 900, such as a program with which the CPU 150 and 250 operate in each of the above-described embodiments. The electronic apparatus 900 may include a storage device such as an HDD (Hard Disk Drive), or a drive to perform reading from and writing to various removable recording media, together with the non-volatile memory 909.

The CPU 911 corresponds to the CPU 150 and 250 in the respective embodiments. The CPU 911 controls each portion of the electronic apparatus 900 including the display 901 by executing the program stored in the non-volatile memory 909 or the like.

The RAM 913 temporarily stores a program with which the CPU 911 operates, or computation parameters of the CPU 911, or the like.

The battery 915 supplies power to each portion of the electronic apparatus 900. In a case where the electronic apparatus 900 is provided with the solar cell 907, the battery 915 is supplied with power from the solar cell 907. In other cases, power is supplied for the battery 915 by power supply from the outside.

Hereinbefore, a description was made with respect to an example of a hardware configuration of the electronic apparatus 900. Each of the above-described constituent elements may be made up of a general-purpose member, or hardware that is specific to a function of each of the constituent elements. In addition, each of the constituent elements may be appropriately changed in response to a technology level when the present disclosure is executed.

### 8. Brief of Embodiments

(1) The above-described embodiments of the present disclosure relate to a display control device including: a display control unit that controls displaying on a display allowing light, which is incident from a rear surface side opposite to an observation surface that is a surface of a side at which an observing user is present, to be transmitted through and to be observed by the user; and a state information acquiring unit that acquires state information representing a rear surface side state of the display. The display control unit changes the displaying on the display in response to the state information.

In the description of the embodiments, the display control device is exemplified as the electronic apparatus 100, 200, 300, 400, 500, or 600. In addition, the display through which the background is transmitted is exemplified as the display 107 or 207 that is a transparent display. The display control unit is exemplified as the display control unit 151 or 251. The state information is exemplified as information that is supplied by the hinge rotation angle sensor 105s, or the switch 205s or 305s. The state information acquiring unit is exemplified as the state information acquiring unit 153 or 253.

According to this configuration, in regard to the displaying on the transparent display in which the rear surface side state may vary, display characteristics such as visibility or expressiveness may be improved by changing the display brightness, display direction, a display content, or the like in response to the rear surface side state.

(2) In the embodiments of the present disclosure, the state information acquiring unit may acquire the state information including information that represents a first state in which the rear surface of the display is opposite to a first surface, and a second state in which the rear surface of the display is not opposite to the first surface, and the display control unit may change the displaying on the display between a case in which the state information represents the first state and a case in which the state information represents the second state.

In the description of the embodiments, the first surface is exemplified as the background surface 109, 209, 409, or 509. In addition, the first state is exemplified as the state in which the display section 101 is closed with respect to the main body section 103, the state in which the display section 201 overlap the top face of the main body section 203, or the state in which the display section 301 is attached to the main body section 303. In addition, the second state is exemplified as the state in which the display section 101 is opened with respect to the main body section 103, the state in which the display section 201 projects from the top face of the main body section 203, or the state in which the display section 301 is detached from the main body section 303.

According to the above-described configuration, in a case where the background of the display becomes the first surface, that is, the rear surface of the display is opposite to a predetermined background surface, the transparent display is used similar to a normal display, in which the background is not transmitted through the display, by changing the displaying in accordance with the background surface, and therefore the visibility or expressiveness of the displaying may be improved.

In addition, in the present disclosure, the state information may not necessarily include the information representing that the rear surface of the display is opposite to the predetermined background surface. For example, the display control device may recognize the rear surface side state of the display at each time with a camera or the like, and may change the displaying in accordance with the recognized state. According to this configuration, the display characteristics of the transparent display may be improved.

(3) In the embodiments of the present disclosure, the state information acquiring unit may acquire, as the state information, operation state information of an engagement mechanism that makes a first section having the display and a second section having the first surface engage with each other, and that changes the first state that is a state in which the display overlaps the first surface and the second state that is a state in which the display is distant from the first surface.

In the description of the embodiments, the first section is exemplified as the display sections 101, 201, or 301. In addition, the second section is exemplified as the main body section 103, 203, or 303. The engagement mechanism is exemplified as the hinge 105, the slide mechanism 205, or the attaching and detaching mechanism 305. An operation state of the engagement mechanism is exemplified as the rotation angle of the hinge 105, the position of the display section 201 that is slid by the slide mechanism 205, or the attached or detached state of the display section 301 by the attaching and detaching mechanism 305. In addition, the “state in which the display overlaps the first surface” in this specification may include not only a case in which the display and the first surface are in a close contact state but also a case in which the display and the first surface approach each other within a range in which the first surface is visible through the display.

According to above-described configuration, when a case in which the transparent display overlaps a specific background and not the case are switched from each other with a mechanical structure, the rear surface side state of the display may be easily recognized by using an operation state of a switching mechanism as the state information.

In addition, in the technology according to the present disclosure, the state information may not necessarily be the operation state information of the mechanism. For example, the state information may be acquired by recognizing an object, which is opposite to the display, with a camera provided in the display section or the like. At this time, the background surface of the display may be recognized by reading out a predetermined code such as a QR code (registered trademark) formed on the background surface. In addition, as another example, the state information may be acquired through data communication using terminals that are provided in the display section and the main body section, respectively.

(4) In the embodiments of the present disclosure, the second state may be a state in which the rear surface of the display is not opposite to a specific surface.

In the description of the embodiments, the state, in which the display section 101, 201, or 301 does not overlap the main body section 103, 203, or 303, corresponds to the second state described here.

According to this configuration, in a case where the background of the display is a background landscape, the displaying is changed in accordance with this state, and thereby displaying utilizing the transparent display characteristics, for example, displaying in which information that is obtained by an AR technology is made to overlap an actual landscape, or the like, may be performed.

(5) In the embodiments of the present disclosure, the second state may be a state in which the rear surface of the display is opposite a second surface that is different from the first surface.

In the description of the embodiments, the first surface and the second surface described here are exemplified as the background surface 409 and the background surface 509 in the sixth embodiment. In addition, in the sixth embodiment, the first state and the second state are exemplified as the state in which the display 107 overlaps the background surface 409, and the state in which the display 107 overlaps the background surface 509.

According to this configuration, in a case where the background of the display may vary between two surfaces in which a surface state is different in each case, the displaying is made to change in accordance with each background, and thereby the visibility or expressiveness of the display in each background may be improved.

(6) In the embodiments of the present disclosure, the state information acquiring unit may acquire the state information including information that represents a third state different from the first state and the second state, and the display control unit may cause a change, which is different from that in a case in which the state information represents either the first state or the second state, to the displaying on the display, in a case where the state information represents the third state.

In the description of the embodiments, the third state is exemplified as the state in which the rotation angle θ of the hinge 105 is in an intermediate value between the first threshold value and the second threshold value, the state in which one of the plurality of switches 205s and 305s is turned on and the other is turned off, or the state shown in FIGS. 9B and 9C in the sixth embodiment.

According to this configuration, the rear surface side state of the display may be delicately recognized and thereby the display may be controlled in a relatively appropriate manner in response to each state.

(7) In the embodiments of the present disclosure, the third state may be an intermediate state in which the rear surface side state of the display in the course of varying between the first state and the second state, and the display control unit may make the displaying on the display temporarily disappear, in a case where the state information represents the third state.

In the description of the embodiments, the third state described here is exemplified as the state in which the rotation angle θ of the hinge 105 is in an intermediate value between the first threshold value and the second threshold value, or the state in which one of the plurality of switches 205s and 305s is turned on and the other is turned off.

According to this configuration, in a case where the intermediate state, in which the background of the display is being changed, is estimated as a state in which a user is unlikely observes the display, the displaying on the display is made to temporarily disappear, and thereby a power consumption may be reduced. In addition, in a state other than a predetermined rear surface side state, the displaying on the display is not performed and thereby the displaying on the display may be prevented from being an unnatural state.

(8) In the embodiments of the present disclosure, the display control unit may change the displaying on the display in response to a pattern or a texture of the first surface, in a case where the state information represents the first state.

In the description of the embodiments, the pattern or texture of the first surface is exemplified as the shape or color of the keyboard 409a and touch pad 409b provided on the background surface 409, or the color or gloss of the solar cell panel 509a that is provided on the background surface 509.

According to this configuration, in a case where any member is disposed on a surface opposite to the rear surface of the transparent display, for example, the display brightness of the display is changed so as to cancel the pattern or texture of the member, and thereby the visibility or expressiveness of the display may be improved.

In addition, the pattern or texture of the background surface may be stored as information in advance, or may be discriminated by recognition of an object with a camera provided in the display section or the like. In addition, the member that may be provided on the background surface is not limited to the keyboard, the touch panel, and the solar cell panel that are exemplified in the description of the embodiments, and may include various members. For example, an electronic paper may be provided on the background surface. In this case, the display control unit may control the displaying on the display so as to perform display associated with display of the electronic paper provided on the background surface. The display of the electronic paper may be called a kind of pattern or texture.

(9) In the embodiment of the present disclosure, the display control unit may change brightness in the displaying on the display in response to the state information.

According to this configuration, for example, the optimal brightness may be set in a case in which the rear surface of the display is opposite to a predetermined background surface and not the case, and thereby the display characteristics of the display may be improved.

(10) In the embodiments of the present disclosure, the display control unit may vertically or horizontally invert the displaying on the display in response to the state information.

According to this configuration, in a case where a direction in which a user observes the display varies while the rear surface state of the display varies, it is possible to cope with this variation by inverting the displaying on the display.

(11) In the embodiments of the present disclosure, the display control unit may change display content of the display in response to the state information.

According to this configuration, the display content may be adapted to the background of the display at each time, for example, by changing a method of displaying information, which is obtained by the AR technology, between a case in which the rear surface of the display is opposite to a predetermined background surface and not the case.

### 9. Supplement

Hereinbefore, description was made in detail with respect to preferred embodiments of the present disclosure with reference to the attached drawings, but the technical scope of the present disclosure is not limited to the corresponding example. It should be understood by those skilled in the art that various modifications or variations may occur within the scope of the technical idea described in the appended claims, and these also pertain to the technical scope of the present disclosure.

In addition, the following configurations belong to a technical scope of the present disclosure.

(1) A display control device including: a display control unit that controls displaying on a display allowing light, which is incident from a rear surface side opposite to an observation surface that is a surface of a side at which an observing user is present, to be transmitted through and to be observed by the user; and a state information acquiring unit that acquires state information representing a rear surface side state of the display. The display control unit changes the displaying on the display in response to the state information.

(2) The display control device according to (1), in which the state information acquiring unit acquires the state information including information that represents a first state in which the rear surface of the display is opposite to a first surface, and a second state in which the rear surface of the display is not opposite to the first surface, and the display control unit changes the displaying on the display between a case in which the state information represents the first state and a case in which the state information represents the second state.

(3) The display control device according to (2), in which the state information acquiring unit acquires, as the state information, operation state information of an engagement mechanism that makes a first section having the display and a second section having the first surface engage with each other, and that changes the first state that is a state in which the display overlaps the first surface and the second state that is a state in which the display is distant from the first surface.

(4) The display control device according to (2) or (3), in which the second state is a state in which the rear surface of the display is not opposite to a specific surface.

(5) The display control device according to (2) or (3), in which the second state is a state in which the rear surface of the display is opposite a second surface that is different from the first surface.

(6) The display control device according to any one of (2) to (5), in which the state information acquiring unit acquires the state information including information that represents a third state different from the first state and the second state, and the display control unit causes a change, which is different from that in a case in which the state information represents either the first state or the second state, to the displaying on the display, in a case where the state information represents the third state.

(7) The display control device according to (6), in which the third state is an intermediate state in which the rear surface side state of the display in the course of varying between the first state and the second state, and the display control unit makes the displaying on the display temporarily disappear, in a case where the state information represents the third state.

(8) The display control device according to any one of (2) to (7), in which the display control unit changes the displaying on the display in response to a pattern or a texture of the first surface, in a case where the state information represents the first state.

(9) The display control device according to any one of (1) to (8), in which the display control unit changes brightness in the displaying on the display in response to the state information.

(10) The display control device according to any one of (1) to (9), in which the display control unit vertically or horizontally inverts the displaying on the display in response to the state information.

(11) The display control device according to any one of (1) to (10), in which the display control unit changes display content of the display in response to the state information.

(12) A display control method including: controlling displaying on a display allowing light, which is incident from a rear surface side opposite to an observation surface that is a surface of a side at which an observing user is present, to be transmitted through and to be observed by the user; acquiring state information representing a rear surface side state of the display; and changing the displaying on the display in response to the state information.

(13) A program that allows a computer to execute: a function of controlling displaying on a display allowing light, which is incident from a rear surface side opposite to an observation surface that is a surface of a side at which an observing user is present, to be transmitted through and to be observed by the user; a function of acquiring state information representing a rear surface side state of the display; and a function of changing the displaying on the display in response to the state information.

It should be understood by those skilled in the art that various modifications, combinations, sub-combinations and alterations may occur depending on design requirements and other factors insofar as they are within the scope of the appended claims or the equivalents thereof.

What is claimed is:

1. A display control device comprising:
a display control unit that controls displaying on a display allowing light, which is incident from a rear surface side opposite to an observation surface that is a surface of a side at which an observing user is present, to be transmitted through and to be observed by the user; and
a state information acquiring unit that acquires state information representing a rear surface side state of the display,
wherein the display control unit changes the displaying on the display in response to the state information.

2. The display control device according to claim 1,
wherein the state information acquiring unit acquires the state information including information that represents a first state in which the rear surface of the display is opposite to a first surface, and a second state in which the rear surface of the display is not opposite to the first surface, and
the display control unit changes the displaying on the display between a case in which the state information represents the first state and a case in which the state information represents the second state.

3. The display control device according to claim 2,
wherein the state information acquiring unit acquires, as the state information, operation state information of an engagement mechanism that makes a first section having the display and a second section having the first surface engage with each other, and that changes the first state that is a state in which the display overlaps the first surface and the second state that is a state in which the display is distant from the first surface.

4. The display control device according to claim 2,
wherein the second state is a state in which the rear surface of the display is not opposite to a specific surface.

5. The display control device according to claim 2,
wherein the second state is a state in which the rear surface of the display is opposite a second surface that is different from the first surface.

6. The display control device according to claim 2,
wherein the state information acquiring unit acquires the state information including information that represents a third state different from the first state and the second state, and
the display control unit causes a change, which is different from that in a case in which the state information represents either the first state or the second state, to the displaying on the display, in a case where the state information represents the third state.

7. The display control device according to claim 6,
wherein the third state is an intermediate state in which the rear surface side state of the display is in the course of varying between the first state and the second state, and
the display control unit makes the displaying on the display temporarily disappear, in a case where the state information represents the third state.

8. The display control device according to claim 2,
wherein the display control unit changes the displaying on the display in response to a pattern or a texture of the first surface, in a case where the state information represents the first state.

9. The display control device according to claim 1,
wherein the display control unit changes brightness in the displaying on the display in response to the state information.

10. The display control device according to claim 1,
wherein the display control unit vertically or horizontally inverts the displaying on the display in response to the state information.

11. The display control device according to claim 1,
wherein the display control unit changes display content of the display in response to the state information.

12. A display control method comprising:
controlling displaying on a display allowing light, which is incident from a rear surface side opposite to an observation surface that is a surface of a side at which an observing user is present, to be transmitted through and to be observed by the user;
acquiring state information representing a rear surface side state of the display; and
changing the displaying on the display in response to the state information.

13. A program that allows a computer to execute:
a function of controlling displaying on a display allowing light, which is incident from a rear surface side opposite to an observation surface that is a surface of a side at which an observing user is present, to be transmitted through and to be observed by the user;
a function of acquiring state information representing a rear surface side state of the display; and
a function of changing the displaying on the display in response to the state information.
